(19) United States
(12) Patent Application Publication
(10) Pub. No.: US 2022/0197528 A1
(43) Pub. Date: Jun. 23, 2022

(54) Method and System for Individually, Digitally Labeling a Solid-state Storage Device

(71) Applicant: Michael Roy Jones, Marion, IA (US)

(72) Inventor: Michael Roy Jones, Marion, IA (US)

(73) Assignee: Verity Industrial Group, Inc., Cedar Rapids, IA (US)

(21) Appl. No.: 17/128,003

(22) Filed: Dec. 19, 2020

(51) Int. Cl. G06F 3/06

(52) U.S. Cl. CPC G06F 3/0643; G06F 3/0679; G06F 3/0604; G06F 3/0653

(57) ABSTRACT

A method and system for individually, digitally labelling a solid-state storage device having a display screen at the time that digital information is written thereon is provided. The method provides for transferring at least a portion of the digital information in the form of a digital data stream to the solid-state storage device from solid-state programing equipment. Information is extracted from the data stream and used to create a digital label that is visible on the solid-state storage device display screen and is accessed through the solid-state storage device human-machine interface. The label displayed on the display screen identifies the digital information that is written on the solid-state storage device.

### CROSS-REFERENCE TO RELATED APPLICATIONS

Claiming the benefit of prior-filed provisional patent application No. 62/949,488 titled “Method and System for Individually, Digitally Labeling a Solid-state Storage Device”.

### FEDERALLY SPONSORED RESEARCH OR DEVELOPMENT

Not Applicable

### BACKGROUND OF THE INVENTION

The present invention provides a system and methods for placing a visual, digital label (24) on a solid-state storage device (10, 19). In particular, the invention is directed to the individual placement of a visual, digital label (24) on a Universal Serial Bus (USB) flash drive (10, 19) or USB Webkey (10, 19) at the time that digital information is recorded thereon. The visual, digital label (24) is displayed on display screen (16, 21) and is navigated with human-machine interface (HMI) (17, 22). Label (24) uniquely identifies the digital information recorded on the solid-state memory module (15).

The USB flash drive with integrated display (10, 19) is a portable solid-state memory device capable of having digital information written thereon when placed in solid-state programing equipment (7) receiving data streams (26, 27) from workstation (2) and/or equipment producing data (1). The USB Webkey with display (10, 19) is a portable solid-state memory device capable of storing digital information representing a Uniform Resource Locator (URL) written thereon when placed in solid-state programing equipment (7) receiving data streams (26, 27) from workstation (2) and/or equipment producing data (1). The USB Webkey can launch a World Wide Web (WWW) page identified by a URL when placed in a computer USB port.

### DESCRIPTION OF THE RELATED ART

USB flash drives are rapidly becoming the physical media of choice for distributing and archiving large data files. Cloud computing data centers accessible through an Internet connection and located with a URL are rapidly becoming the non-physical media of choice for distributing and archiving large data files. USB Webkeys are physical media capable of distributing a cloud computing URL and automating the process of launching the URL in a WWW browser.

When using a USB flash drive or USB Webkey for data distribution and/or archiving, it is important to label the solid-state storage device adequately identifying the digital data written thereon. For example, accurately labeling solid-sated storage devices when used to distribute &/or archive patient medical information is crucial to ensure the correct patient receives the correct solid-state storage device. For example, accurately labeling solid-sated storage devices when used to distribute &/or archive evidence supporting criminal investigations or financial transactions is crucial to ensure the correct recipient receives the correct solid-state storage device.

It is not cost effective to silk screen a label that uniquely identifies the digital information written on a USB flash drive or USB Webkey, as is the current mass production method. It also is not cost effective to inkjet or thermal print a unique label on a USB flash drive or USB Webkey itself, as is the current on-demand production method. Present methods for a creating a label that uniquely identify the digital information written on USB flash drives and USB Webkeys include manually writing or computer printing identification information on a physical label and manually attaching the label to the solid-state storage device. Present methods also include taking a pen or marker and writing identification information on the surface of the solid-sate device itself. Manual techniques are error prone and time consuming.

It would therefore be desirable to provide a system and methods for placing and displaying a unique label on each solid-state storage device at the time that digital information is written thereon, without requiring the manual writing of identification information on a separate label that is to be attached to the solid-state device, or the manual writing of information on the solid-state storage device itself. By eliminating manual labeling, the greatest product quality, data integrity, and label accuracy, as well as improved production cycle time can be assured.

MPEG Audio Layer-3 (MP3) players are solid-state devices combining storage and audio/video play function. MP3 players can include an integrated display screen and HMI for the purpose of navigating the device's file system and initiating audio/video play function. MP3 players are too expensive to provide a system and methods for placing a visual, digital label (24) on a solid-state storage device (10, 19). The excessive cost is driven by the audio/video play function and complex HMI required to navigate the device's whole file system. Additionally, MP3 devices do not support labeling automation at the time that digital information is recorded thereon. A less capable, less expensive and automated system and method is needed to create and place a visual, digital label (24) on a solid-state storage device (10, 19) at the time that digital information is recorded thereon.

“EZVue usb flash drive” is a flash drive with scrollable display and HMI. ROYAL Vista is the “EZVue usb flash drive” manufacturer. Product information can be found at URL: https://newatlas.com/new-flash-drive-with-scrollable-display-of-stored-files-plus-sd-card-readerwriter/5416/. “EZVue usb flash drive” includes an integrated display screen and HMI for the purpose of viewing the device's whole file system. “EZVue usb flash drive” was introduced to the market in 2006 and did not gain market acceptance due to excessive cost driven by the complex integrated display screen and HMI required to navigate the devices' whole file system. Additionally, this device does not support labeling automation at the time that digital information is recorded thereon. A less capable, less expensive and automated system and method is needed to create and place a visual, digital label (24) on a solid-state storage device (10, 19) at the time that digital information is recorded thereon.

It would therefore be desirable to provide a system and methods for writing and displaying a unique label on each solid-state storage device at the time that digital information is written thereon that supports automation. It would therefore be desirable to provide a system and methods for writing and displaying a unique label on each solid-state storage device at the time that digital information is written thereon that reduces cost by eliminating complex audio/video play functions and complex HMI and electronics for the purpose of viewing the device's whole file system.

### BRIEF SUMMARY OF THE INVENTION

A method and system for individually, digitally labelling a solid-state storage device (10, 19) having a display screen (16, 21) at the time that digital information is written thereon is provided. The method provides for transferring at least a portion of the digital information in the form of a digital data stream (28) to the solid-state storage device (10, 19) from solid-state programing equipment (7). Information is extracted from the data stream (26, 27) and used to create a digital label (24) that is visible on the solid-state storage device display screen (16, 21) and is accessed through the solid-state storage device human-machine interface (17, 22). The label (24) displayed on the display screen (16, 21) identifies the digital information that is written on the solid-state storage device (10, 19).

### DESCRIPTION THE DRAWINGS

FIG. 1: A method and system for individually labelling a solid-state device having a display screen at the time that digital information is written thereon is provided. The system includes Equipment Producing Data, Workstation, Solid-state Programing Equipment, and Solid-state Device with integrated Display Screen.

FIG. 2: Solid-state Storage Device having digital storage capacity, an integrated Display Screen for displaying a label identifying the digital data stored in the device, an integrated HMI to navigate/scroll the Display Screen, and Power Switch.

FIG. 3: Visual, Digital Label that uniquely identifies the digital data stored on the Solid-state Storage Device.

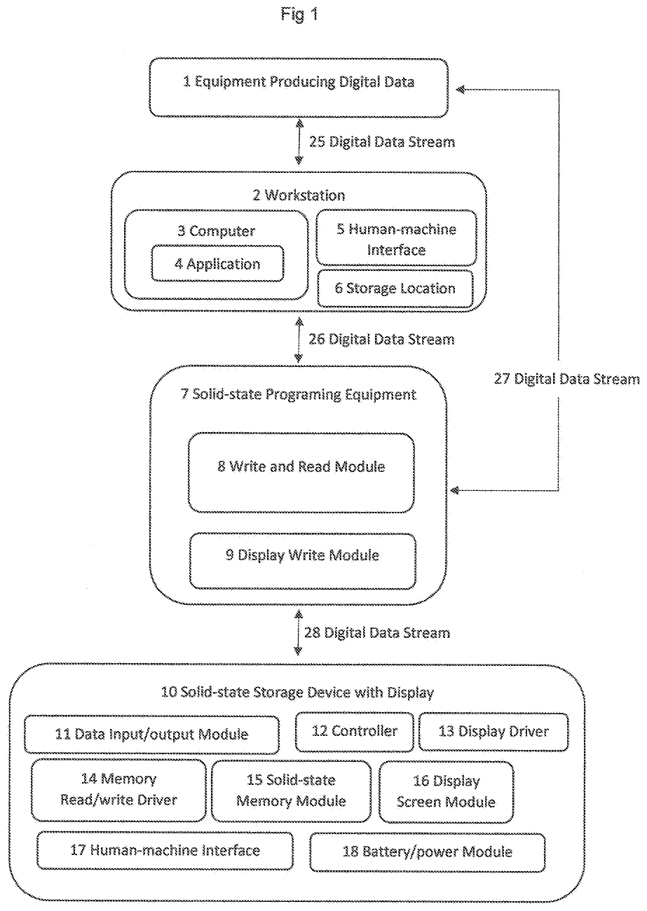

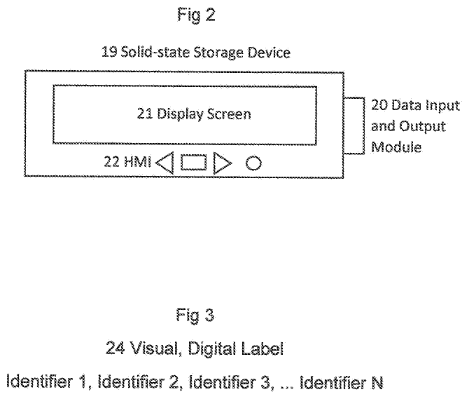

### DETAILED DESCRIPTION OF THE INVENTION

The present invention provides a system and methods for creating and placing a visual, digital label (24) on a solid-state storage device (10, 19) at the time that digital information is recorded thereon. Label (24) uniquely identifies the digital information recorded on solid-state storage device (10, 19). Label (24) is placed on display screen (16, 21). Label (24) is created from identification information extracted from the digital information recorded on solid-state storage device (10, 19) at the time that digital information is recorded thereon.

The present invention provides a system including workstation (2), solid-state programing equipment (7), solid-state storage device with display (10, 19). The workstation (2) communicates with and stores data from equipment producing data (1). The workstation (2) also communicates with solid-state programing equipment (7). The workstation includes a communication controller, a computer (3), software application (4), HMI (5), and storage location (6) all connected to a common data bus. The programing device (7) communicates independently with equipment producing data (1) and the workstation (2) managed by write and read module (8). The solid-state programing device (7) includes a write and read module (8) and display write module (9) both connected to a common data bus. The solid-state programing device (7) communicates with the solid-state storage device (10, 19) with display (16, 21) via data input/output module (11). The solid-state storage device with display (10, 19) includes data input/output module (11), controller (12), display driver (13), memory read/write driver (14), solid-state memory module (15), display screen module (16, 21), HMI (17, 22), and battery/power module (18) all connected to a common data bus.

In an exemplary embodiment of the present invention, at least a portion of the digital information from equipment producing data (1) is transferred in the form of digital data stream (25) to a storage location (6). At least a portion of the digital information from a storage location (6) is transferred in the form of a digital data stream (26) to programing equipment (7). Information that uniquely identifies the data present in data stream (26) is extracted from data stream (26) by write and read module (8). A visual, digital label (24) is created from the extracted identification information. Label (24) is transmitted (28) to data input/output module (11) by the display write module (9). The data input/output module (11) communicates with the memory read/write driver (14) and records label (24) to solid-state memory module (15). Display driver (13) reads label (24) from solid-state memory module (15) and places label (24) on solid-state storage device (10, 19) display screen (16, 21). Digital information (content) intended for distribution and/or archiving is extracted from data stream (26) and transmitted (28) to data input/output module (11) by the write and read module (8). The data input/output module (11) communicates with the memory read/write driver (14) and records the digital information (content) to solid-state memory module (15).

In an exemplary embodiment of the present invention, at least a portion of the digital information from equipment producing data (1) is transferred in the form of digital data stream (27) to programing equipment (7). Information that uniquely identifies the data present in data stream (27) is extracted from data stream (27) by write and read module (8). A visual, digital label (24) is created from the extracted identification information. Label (24) is transmitted (28) to data input/output module (11) by the display write module (9). The data input/output module (11) communicates with the memory read/write driver (14) and records label (24) to solid-state memory module (15). Display driver (13) reads label (24) from solid-state memory module (15) and places label (24) on solid-state storage device (10, 19) display screen (16, 21). Digital information (content) intended for distribution and/or archiving is extracted from data stream (26) and transmitted (28) to data input/output module (11) by the write and read module (8). The data input/output module (11) communicates with the memory read/write driver (14) and records the digital information (content) to solid-state memory module (15).

In an exemplary embodiment of the present invention, workstation (2) and solid-state programing devices can be combined into a single device. Specifically, programing devices (7) can be integrated into workstation (3) computer (2). In another exemplary embodiment, programing device (7) is a stand-alone device, with multiple USB ports, connected to workstation (2) via a standard method like serial, ethernet, USB, or WiFi.

In an exemplary embodiment of the present invention, application (4) can incorporate one-of-many commercially available applications capable of processing the Digital Imaging and Communications in Medicine (DICOM) formatted digital content in data streams (25, 26). One such application is Perennity DICOM. Current, commercially available applications do not have the capability to extract patient and procedure identifiers in a fashion to create label (24) and place label (24) on solid-state storage device (10, 19) display screen (16, 21). Label (24) creation and placement is described in the present invention solid-state programing equipment (7) write and read module (8).

An aspect of the system is having more than one equipment producing data (1) connected to the workstation (2). Another aspect of the system is having more than one equipment producing data (1) connected to the solid-state programing equipment (7).

Another aspect of the system is having more than one equipment producing data (1) and workstation (2) simultaneously connected to the solid-state programing equipment (7).

Another aspect of the system is the solid-state programing equipment (7) can have more than one port to accommodate synchronous or asynchronous recording of multiple solid-state storage devices (10).

Another aspect of the systems is solid-state programing equipment (7) can record to both USB drives (10, 19) and USB Webkey's (10, 19), synchronously or asynchronously.

Another aspect of the system is the solid-state programing equipment (7) is multiple solid-state storage devices (10) can be loaded into multiple ports manually or through robotic automation.

Another aspect of the system is the display screen module (16, 21) can utilize display technology, such as liquid crystal display (LCD), light emitting diode (LED), polymer dispersed, electrochromic, or micro-mechanical. The display screen (16, 21) can utilize illumination methods, such as reflective, transmissive, emitting, font, back, waveguide, or self-emitting. The display screen (16, 21) can use addressing methods, such as active, passive, and/or bi-stable.

An aspect of the system is the equipment producing data (1) can be a computer-aided medical imaging device generally referred to as modality, such as Computed Tomography (CT), Digital Subtracted Angiography, and Magnetic Resonance Imaging (MRI).

Another aspect of the system is workstation (2) can be a digital image storage and management systems known as Picture Archive Communication Systems (PACS) that communicate with and store images from modalities (1). PACS (2) are capable of storing and transmitting a large amount of medical image data in digital form, often in the DICOM format.

An aspect of the method is utilizing the DICOM format to encode content in digital data streams 25, 26, 27, and 28. The DICOM format can encode medical image objects and one or more metadata objects including patient name and identification number. Data stream 28 utilizes the USB protocol.

Another aspect of the method is embedding a DICOM viewer application in digital data stream (26, 28) via the workstation (2) application (4). In this way, the digital data stream (26, 28) will contain both a DICOM study (medial images and metadata) and a DICOM viewer. Including a DICOM viewer is useful when the solid-state storage devices with display (10, 19) is a USB drive.

Another aspect of the method is embedding a URL in digital data stream (26) via the workstation (2) application (4). The URL can point to a DICOM study stored in a cloud facility. Including URL in data stream (26, 28) is useful when the solid-state devices with display (10, 19) is a Webkey. Another aspect of the method is embedding label (24) in digital data stream (26) via the workstation (2) application (4).

Another aspect of the present invention is utilization of encryption for at least a portion of the data stored in solid-state memory module (15).

Another aspect of the present invention is utilization write-once-read-many methods for at least a portion of the data stored in solid-state memory module (15).

A preferred embodiment of the present invention provides for multiple modalities (1) transmitting DICOM formatted digital data streams (25) to a networked PACS workstation (2). A preferred embodiment of the present invention also provides for a USB flash drive programing device (7), having multiple USB ports, communicating with the PACS workstation (2) via DICOM formatted digital data stream (26) utilizing an industry standard protocol, such as ethernet. A preferred embodiment of the present invention also provides for a USB flash drive (10, 19) having an integrated Light Emitting Diode (LED) display (16, 21) and HMI (17, 22). The LED display (16, 21) and HMI (17,22) are solely for the purpose of displaying label (24) on display screen (16, 21). The programing device (7) write and read module (8) routes the data stream (26) to one of the programing device's (7) USB ports. The programing device (7) write and read module (8) extracts patient name, patient identification number, and procedure identifier from the DICOM formatted data stream (26) and creates a digital label (24) displaying at least patient name, patient identification number, and procedure identifier. Also, the programing device (7) write and read module (8) creates an Autorun.inf file named “Autorun.inf” containing at least the following two lines of text, whereas, “LABEL (24)” is the actual label (24) text containing patient name, patient identification number, and procedure identifier: [autorun], Label=“LABEL (24)”.

Autorun.inf file is transmitted (28) to data input/output module (11) by the display write module (9). The data input/output module (11) communicates with the memory read/write driver (14) and records the Autorun.inf file to solid-state memory module (15). Display driver (13) extracts label (24) from the Autorun.inf file stored on the solid-state memory module (15) and places label (24) on solid-state storage device (10, 19) display screen (16, 21).

Additionally, the patient's DICOM study (content) intended for distribution and/or archiving is extracted from data stream (26) and transmitted (28) to data input/output module (11) by the write and read module (8). The data input/output module (11) communicates with the memory read/write driver (14) and records the DICOM study to solid-state memory module (15). When the solid-state storage device with display (10, 19) is a USB flash drive, the result is a USB flash drive containing a patient's DICOM study in memory (15) and a label (24) showing at least the patient's name, identification number, and procedure identifier on a LED display (16, 21). This method ensures USB flash drive's digital label (24) accurately identifies the DICOM study stored thereon (15).

In another exemplary embodiment of the present invention, label (24) is an image file readable by display driver (13). The image file displays at least the patient's name and identification number. The image file can incorporate additional information, such as a logo or graphic.

Novel aspects of the present invention include [a] a method for extracting unique patient and procedure identifiers from DICOM formatted digital data for the purpose of creating a digital label (24), [b] a method for generating a URL pointing to the patient's DICOM study stored in a cloud facility, [c] Webkey device (10, 19) with an integrated display (16, 21) and HMI (17, 22) solely for the purpose of displaying label (24), [d] solid-state programing device (7) placing the digital label (24) on the Webkey's display (16, 21) and writing the URL to the Webkey's memory (15), [e] a method ensuring Webkey's digital label accurately identifies the DICOM study stored thereon.

Other novel aspects of the present invention include [a] method for extracting unique patient and procedure identifiers from DICOM formatted digital data for the purpose of creating a digital label (24), [b] method for reading and writing DICOM digital study from PACS (2) and/or modalities (1), [c] USB drive (10, 19) with an integrated display (16, 21) and HMI (17, 22) for the purpose of displaying label (24), [d] solid-state programing device (7) placing the digital label (24) on the USB drive's display (16, 21) and writing the DICOM study to the USB drive's memory (15), [e] method ensuring USB flash drive's digital label accurately identifies the DICOM study stored thereon, and [f] display driver (13) extracting label (24) from Autorun.inf file and placing on display screen (16, 21).

1. A solid-state storage device with integrated display comprising:
a display screen;
a digital label;
a display driver;
a data input/output module;
a human-machine interface;
a solid-state memory module;
a memory read/write driver;
a controller; and
a battery/power module
wherein said data input/output module receives digital data stream containing said digital label and digital content,
wherein said digital label identifies digital content,
wherein said data input/output module extracts and transmits said digital label to said memory read/write driver,
wherein said memory read/write driver records said digital label to said solid-state memory module,
wherein said display driver reads said digital label from said solid-state memory module and places said digital label on said display screen creating a human readable, visual label,
wherein said data input/output module extracts and transmits digital content to said memory read/write driver,
wherein said memory read/write driver records digital content to said solid-state memory module,
wherein said digital label displayed on said display screen identifies the digital content written on the said solid-state memory module,
Wherein said digital label is recorded to said solid-state memory module at the time that digital content is recorded to said solid-state memory module.

2. A solid-state storage device with integrated display as recited in claim 1, wherein said solid-state storage device is a Universal Serial Bus (USB) flash drive and said data input/output module utilizes USB communication protocol.

3. A solid-state storage device with integrated display as recited in claim 1, wherein said solid-state storage device includes USB Webkey Uniform Resource Locator (URL) launching capability and digital content is a URL and said data input/output module utilizes USB communication protocol.
